(19) United States
(12) Patent Application Publication
(10) Pub. No.: US 2013/0132222 A1
(43) Pub. Date: May 23, 2013

(54) Method and Apparatus Pertaining to Financial Investment Quantitative Analysis Signal Auctions

(71) Applicants: Paul Sutter, San Francisco, CA (US); Stefan Petry, Menlo Park, CA (US)

(72) Inventors: Paul Sutter, San Francisco, CA (US); Stefan Petry, Menlo Park, CA (US)

(21) Appl. No.: 13/299,447

(22) Filed: Nov. 18, 2011

(51) Int. Cl. G06Q 40/06; G06Q 30/08

(52) U.S. Cl. 705/26.3

(57) ABSTRACT

A server receives identifying information regarding a plurality of signals pertaining to financial investment quantitative analysis from various third parties. At least some of this identifying information is then posted and on-line auctions are conducted for individual ones of this plurality of signals.

### TECHNICAL FIELD

This invention relates generally to financial investment quantitative analysis signals.

### BACKGROUND

Quantitative analysts are known in the art. These are typically professionals who work in finance using numerical or quantitative techniques. A typical problem for a numerically-oriented quantitative analyst, for example, would be to develop a model (using quantifiable data) for pricing, hedging, and risk-managing a complex derivative product. In the investment industry, people who perform quantitative analysis are often called quants. Many quantitative analysts spend the majority of their time programming and operating computers to perform in these particular regards.

A quantitative analyst's work-product deliverable, often termed a “signal,” provides financial decision makers (such as traders) with data to inform their financial decisions. These signals are typically not a simplistic “buy” or “sell” conclusion. Instead, signals are often analytical results that can help to make such decisions. In many cases, however, a signal comprises a stream of data (including raw data) that feeds into an algorithm that in turn produces a higher-level signal as a function, at least in part, of that first signal.

A trivial but nevertheless illustrative example of a signal is the length of women's skirts. More particularly, there is a sometimes-observed notion that stock prices tend to rise as skirts shorten and fall as skirts lengthen. The idea behind this theory is that shorter skirts tend to appear in times when general consumer confidence and excitement is high, meaning the markets are bullish. In contrast, the theory says long skirts are worn more in times of economic fear and general gloom, indicating that things are bearish. For one who places their faith in such a view, skirt length comprises a signal that does not literally equate to a buy or sell decision for a particular stock but that can nevertheless inform such a decision.

At present, the work of quantitative analysts comprises a largely insular activity. This can lead to any number of concerns and issues. As one example, a hedge fund that relies only on the activities of its own in-house quants is singularly subject to the risk that those quantitative analysts, likely working in a decidedly secret environment, will miss something new when it comes along. For example, the Internet is creating many new data sources not previously available for financial analysis. These can include consumer search queries, consumer purchase activity, estimates regarding advertising spending estimates by various companies or industries, processed satellite imagery, signals extracted from the audio of conference calls, user postings on social media services (such as Tweets), and so forth. A small quant team can be hard-pressed to devote the time needed for speculative analysis of these nontraditional datasets.

### BRIEF DESCRIPTION OF THE DRAWINGS

The above needs are at least partially met through provision of the method and apparatus pertaining to financial investment quantitative analysis signal auctions described in the following detailed description, particularly when studied in conjunction with the drawings, wherein:

FIG. 1 comprises a flow diagram as configured in accordance with various embodiments of the invention; and

FIG. 2 comprises a block diagram as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a server receives identifying information regarding a plurality of signals pertaining to financial investment quantitative analysis from various third parties. At least some of this identifying information is then posted and corresponding on-line auctions are conducted for individual ones of these signals.

These teachings are highly flexible in practice and will accommodate a wide variety of approaches in these regards. For example, one or more of these auctions can offer exclusive use of a particular signal for a period of time while another such auction could offer non-exclusive use for a corresponding signal. As yet another example, one auction could encompass both of these approaches. This might comprise permitting a single winning bidder to have exclusive access to a freshest version of the signal and then permitting, some time latter, a plurality of other winning bidders to share access to a less-fresh version of the signal.

As another example in these regards, these teachings will accommodate an auction for an existing and presently-available signal. By another approach, however, these teachings will also accommodate an auction for a prospective and presently-unavailable signal.

When posting the aforementioned identifying information regarding these signals, if desired, these teachings will also accommodate posting additional related information. This can comprise, for example, posting information regarding past performance of one or more of these signals as a predictor of one or more metrics of interest. This could also comprise, if desired, posting information regarding past performance of the corresponding third party with respect to providing accurate signals.

As another example of the flexible nature of these teachings, if desired, one can vet the aforementioned third parties to authenticate, for example, their authorized status to offer their respective signal(s) via an on-line auction. As another example in these regards, these teachings will also accommodate offering and providing, via the same server platform, use of software-based financial-investment analysis tools (to facilitate, for example, using and leveraging a particular signal that a bidder has won via such an auction).

So configured, quantitative analysts can have the opportunity to build a reputation for themselves amongst a wider community of information consumers and traders and to generally have an improved opportunity to reap the value of their efforts. At the same time, the information consumers and traders have improved access to a richer set of signals by which to inform their financial decisions. These teachings will also support a variety of other behaviors and activities that can serve to greatly leverage existing resources. As one example, smaller investors could collaborate to form a winning a bid in competition with larger, better-funded bidders and hence have access to superior information. As another example, these teachings will permit auctioning off several copies of a given data set (with several auction formats being available to support such an approach and to help determine the price that the winning bidders will individually pay.

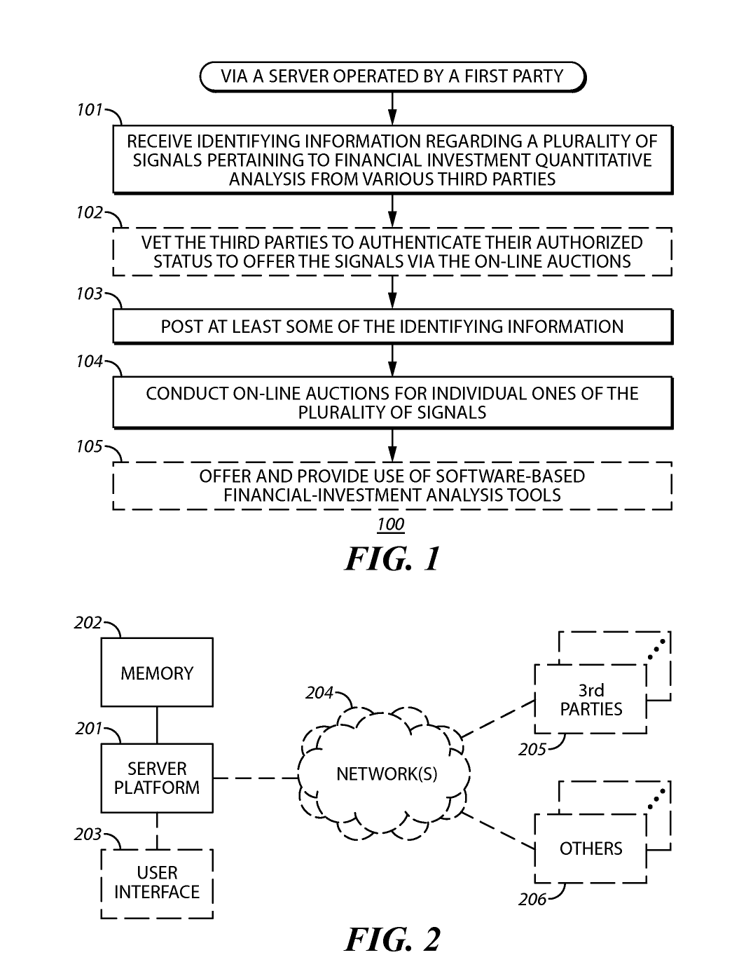

These and other benefits may become clearer upon making a thorough review and study of the following detailed description. Referring now to the drawings, and in particular to FIG. 1, an illustrative process 100 that is compatible with many of these teachings will be presented.

For purposes of illustration this process 100 is described as being carried out via a server operated by a first party. With momentary reference to FIG. 2, this server can comprise, for example, a server platform 201 that operably couples to a memory 202. Server platforms are generally well understood in the art, as are memories, and therefore for the sake of brevity further elaboration in these regards will not be provided here save to note that such components can each comprise, as desired, a plurality of corresponding components. As one simple illustrative example, the server platform 201 can comprise, by one approach, a so-called server farm.

To accommodate at least some application settings an optional user interface 203 of choice can also operably couple to the server platform 201. This user interface 203 can serve, for example, to permit an end user, administrator, or other authorized person to enter information into the server platform 201, to instruct the server platform 201 in certain regards, or to receive information from or via the server platform. Again, user interfaces in these regards also comprise a well-understood area of endeavor and further elaboration is not required here.

Referring again to FIG. 1, and as already noted, this server can be operated by a first party. This first party can comprise, for example, an individual or an enterprise of essentially any nature and type (including but not limited to a loose affiliation of persons, a corporation, a partnership, a fraternal body, a non-profit organization, and so forth). In many cases this first party will comprise both the owner and the operator of the server. These teachings will also accommodate, however, operation of the server by a first party who serves an administrative function but who does not share in the ownership of the server and/or in the described services supported by that server.

At step 101 this process 100 provides for receiving identifying information regarding a plurality of signals pertaining to financial investment quantitative analysis from various third parties (that is, parties other than the first party though, if desired, one or more of these signals might also be sourced by the first party as well). Again, these third parties can comprise any manner of legally-recognized entity regardless of how formally or informally instantiated. Referring again momentarily to FIG. 2 these third parties 205 can submit this identifying information, by one approach, via one or more intervening networks 204 (such as but not limited to the Internet). (FIG. 2 also illustrates that any number of other parties 206 can access the server platform 201 via the aforementioned network(s) 204. These other parties 206 can comprise, for example, persons seeking to place bids in on-line auctions as described herein.)

Referring again to FIG. 1, the server can receive this identifying information via essentially any communications bearer. This can include, but is not limited to, receiving some or all of the identifying information in (or attached to) email, via a file transfer, or pursuant to a browser-based data presentation and entry paradigm. By another approach, in lieu of the foregoing or in combination therewith, this can include receiving a network link (such as a hyperlink) that leads to such information via one or more intervening networks.

The identifying information can vary greatly with the application setting and in accordance with the needs and requirements of the participating parties. By one approach, this information can include data, such as metadata, that characterizes and/or describes the signals in some relevant way. This can include, by way of example, information such as:

A moniker or service mark as corresponds to the signal;

A representation regarding the age of the signal's methodology;

The name(s) of the quantitative analyst(s) and/or organization that developed the signal;

A corresponding quality metric (for example, as might be computed from reviews of this analyst by other buyers or users;

Past quantitative or qualitative performance of the signal (with or without present access being provided to previous signal data to facilitate review and analysis);

Content or links pertaining to expert discussions and financial models that were built on the signal previously;

The raw data that feeds the signal;

The type of auction or auction format;

The duration of future signal delivery (for example, whether the signal will be delivered or available for one week, one week, one year, and so forth);

The frequency of signal updates;

The format of the signal and technical requirements to receive the signal;

Auction start and close time;

Accepted currency or payment type(s);

Bidder qualifications and bidder qualification process details, payment terms, auction rules, and so forth; and

Information regarding specific data licensing terms and restrictions.

At optional step 102 this process 100 provides for vetting one or more of the aforementioned third parties to authenticate their authorized status to offer these signals as per these teachings In one application setting, for example, these third parties might first register themselves with the first party. By one approach this registration activity might simply provide for an a priori mechanism by which a given third party can later present the aforementioned identifying information in a way that assures a firm and knowing linkage between the submitting party and the identified information. In such a case, for example, each third party may have an individual log-in identifier and password, passphrase, or the like that the server utilizes to vet the third party as described.

By another approach this step 102 may provide for a substantive vetting of the third party. This substantive vetting may occur prior to when the identifying information is submitted, at the time of submitting the information, and/or subsequent to the submission of such information as desired. This substantive vetting can include inquiries and/or confirmations regarding such things as:

The third party's legal name, address, and other contact information;

The length of time that the third party has been in the business of developing, working with, or offering such signals;

Conflicts of interest;

Records of success and failure with respect to signal development, usage, or offerings;

And so forth.

By one approach, when a given third party cannot be satisfactorily vetted, the first party can decline to further process the corresponding identifying information as per these teachings By another approach, these teachings will accommodate following up with the particular third party to remedy the apparent deficiencies and to then successfully account for that third party as per this step 102.

In any event, at step 103 this process 100 provides for posting at least some of the identifying information described above. This can comprise, by one approach, publishing this information at a corresponding website. For example, abridged (or unabridged) versions of the identifying information can be provided to permit interested persons to quickly peruse a number of such offerings. Corresponding links can also be provided to permit the viewer to select a particular item and receive further information regarding the selected item (such as, for example, the totality of the identifying information).

As another example, in lieu of the foregoing or in combination therewith, this publishing step can comprise pushing the identifying information to one or more predetermined recipients using any of a variety of methodologies (such as emails, tweets, any of a variety of web feeds such as Really Simple Syndication (RSS) feeds, any of a variety of text feeds such as Short Message Service (SMS), and so forth). In such a case the pushed information can comprise parts or all of the identifying information itself, characterizing information as pertains to that identifying information, a link to lead the viewer to such information, and such other information as may be desired (such as, but not limited to, information regarding an auction for a signal as pertains to this particular identifying information).

As noted earlier, the identifying information contemplated herein can vary widely from one application setting to another. This, in turn, can lead to corresponding differences with respect to what particular information is posted as per this step 103. By one approach, for example, the posted information can include information regarding past performance of at least one of the plurality of signals as a predictor of at least one metric of interest (such as the likelihood of a particular stock to increase or decrease by a particular percentage as compared to a particular sector, index, or the market at large). Information regarding past performance can be provided as text or, for example, in a graphic form (using any of a variety of graph and chart formats as desired).

As another illustrative example in these regards, this step 103 can comprise the positing of information regarding the past performance of one or more of the aforementioned third parties with respect, say, to providing accurate signals. Information such as this can be helpful, for example, when considering what amounts to a new signal or a signal result that relies upon a new raw data source.

In any event, at step 104 this process 100 provides for conducting on-line auctions for individual ones of the plurality of signals. These teachings are highly flexible in this regard and will accommodate a wide range of corresponding variations as to the format, terms, and procedures that characterize these auctions.

By one approach, for example, on-line bids can be accepted for some specified period of time for a particular signal with the ultimate highest bidder receiving the exclusive right to access and utilize that signal. By another approach, tying bids may be accepted such that each of a plurality of tying winning bidders will individually receive the non-exclusive (or semi-exclusive) right to access and utilize the signal.

This attained right to access and utilize the signal may be exclusive (or semi-exclusive) for some specified period of time, such as a few hours or a few days. In such a case, these teachings will also accommodate permitting other bidders to acquire the right to access and utilize a given signal at a later time. For example, and by way of illustration and without intending any limitations in these regards, a highest-bidding party may receive an exclusive right to access and utilize a given signal for two days, following which a second-highest-bidding party then receives a right to also access and utilize that same signal. By this approach, a first number of winning bidders can each receive a fresher version of the signal while a second number of winning bidders each receives a less-fresh version of the same signal.

As a related variation in these regards, such an auction can comprise, if desired, a number of differing tiers where each tier defines a specific type of access, use, or variation as pertains to a particular signal. One such tier, for example, could specify exclusive access to the signal at the time the auction closes to a single highest-bidding party. Another such tier could, in turn, specify non-exclusive access to the signal at a time that begins at some specific time following the closing of the auction (for example, a certain number of hours or days) to a second highest-bidding party.

These teachings will readily accommodate conditioning the buyer's use of the signal if desired. As one simple example in these regards, a given auction could specify and require that the buyer not use the signal in any way other than for predictive analytics for financial market trading. As another example a given auction could specify and require that the buyer not use the signals for promotional or advertising purposes.

As noted earlier these teachings are highly scalable in practice. These auctions, for example, can readily accommodate both existing and presently-available signals as well as prospective and presently-unavailable signals. Accordingly, the auctions signals can represent information that is readily available for use at the close of a given auction or that will only become available at some time in the future following the close of such an auction.

By one approach, these auctions will each comprise receiving bids for individual ones of the plurality of signals. If desired, however, these teachings will also accommodate permitting receipt of a single bid that applies to a group of signals. This may be appropriate, for example, when auctioning, say, three different signals that all pertain to near-term prospects for a particular commodity (such as a particular mineral, crop, or the like).

This step 104 of conducting on-line auctions can readily comprise receiving bids that each represent a fixed level of consideration (such as a specific monetary amount expressed in a particular currency of choice). This step 104 will also accommodate other approaches in these regards, however. For example, bids for a particular signal can be expressed as a contingent level of consideration. As one illustrative example in these regards, a given bid might indicate payment of a first amount in the event the signal predicts a given result of circumstance within a given measure of accuracy, and a second (lesser) amount in the event the signal's prediction ultimately proves to be less accurate.

As yet another example of these teaching's flexibility, such an auction can comprise, if desired, an on-line auction that is contingent upon being able to successfully access at least one other auctioned signal or data source. For example, a first signal being auctioned may require a suitable data source. In such a case, the use and value of that first signal is contingent upon having access to that suitable data source. To accommodate such a circumstance, the winning bidder's obligation to follow through with respect to acquiring the first signal can be made contingent upon that same bidder's having successfully acquired a right to timely access that suitable data source.

And as yet another example of these teaching's flexibility, a given auction can accommodate a considerable amount of dynamic flexibility if desired. To illustrate by way of an example, a given daily signal could be offered on a monthly basis and buyers could be permitted to stipulate that they are unwilling to accept data that is delayed by more than one day. By one approach the seller can be provided with some discretion as to how limited or unlimited a prospective buyer may be in these regards. As another example, the seller could accept a first bid from one buyer who is willing to pay for 1-day exclusive access to such a signal while also accepting other bids from other buyer who are willing to accept that 1-day delay.

In addition to on-line auctions for signals, these teachings will also accommodate conducting other auctions as well if desired. This can comprise, for example, conducting auctions that offer access to pre-signal data that is presented as a suitable data source for at least one corresponding signal as pertains to financial investment quantitative analysis.

This process 100 will also accommodate the optional step 105 of offering and providing use of software-based financial-investment analysis tools. Such access can itself be auctioned as described above or can be offered on a per-use or subscription-based service plan. These tools can be developed, offered, and/or maintained by the aforementioned first party or by any one or more of the aforementioned third parties as may be desired. The particular nature and scope of such tools can of course vary widely and can be as specifically-tied to the signals being auctioned, or as agnostic, as may be useful to the particular application setting. Many such tools are already known in the art and many others will no doubt be developed in the future. As these teachings are not particularly sensitive to any specific choices in these regards, further elaboration will not be provided here.

So configured, these teachings permit quantitative analysts to potentially find a wider (and potentially more-appreciate) audience for their signals. At the same time, those who seek to utilize and rely upon such signals to guide their investment decisions will have access to a potentially richer pool of opportunities in these regards. The great flexibility and scalability of these teachings will accommodate a wide variety of preferences and differing circumstances in these regards, and those skilled in the art will appreciate that these approaches can be readily implemented in a highly cost-effective manner.

It will also be appreciated that these teachings can be applied to a wide variety of buy-side research analysts in addition to quantitative analysts. Just by way of example, while there are about 150,000 funds of all kinds in the world only about 10% of these are hedge funds and only 2% are quant funds. Accordingly, the disclosed approaches have a considerably greater range and scope of applicability beyond the realm of the traditional quant.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

As but one simple example in these regards, one or more of the aforementioned auctions could be supplemented with a buy-it-now option to permit an interested bidder to bring the auction to an immediate close by offering a bid that matches a buy-it-now price. As another simple example in these regards, any of these auctions can be made subject to a reserve price such that no winning bid will be honored unless that bid at least matches a specified minimum bid.

As another simple example, these same approaches could be utilized to auction raw data sources and/or intermediary signals in addition to fully processed trading signals if desired. A raw data source might comprise, for example, a collection of recorded question-and-answer sessions with insiders for a particular industry and a corresponding intermediary signal in those regards might comprise, for example, the results of a lie-detector analysis as applied to that audio content.

And as yet another simple example, these approaches could accommodate the distribution of signals without payment to facilitate, for example, basis academic research. Academic researchers, for example, could be permitted to sign up and to indicate their interest in a particular auctioned signal to thereby gain access to that signal following some period of time such as two weeks, two months, or such other duration as may be designated.

I claim:

1. A method comprising:
via a server operated by a first party:
receiving identifying information regarding a plurality of signals pertaining to financial investment quantitative analysis from various third parties;
posting at least some of the identifying information;
conducting on-line auctions for individual ones of the plurality of signals.

2. The method of claim 1 wherein the on-line auctions include at least one auction offering exclusive use of a corresponding one of the plurality of signals for a period of time.

3. The method of 1 wherein the on-line auctions include at least one auction offering an existing and presently-available signal.

4. The method of claim 1 wherein the on-line auctions include at least one auction offering a prospective and presently-unavailable signal.

5. The method of claim 1 wherein posting at least some of the identifying information includes posting information regarding past performance of at least one of the plurality of signals as a predictor of at least one metric.

6. The method of claim 5 wherein posting information regarding the past performance comprises posting graphic information regarding the past performance.

7. The method of claim 1 wherein posting at least some of the identifying information includes posting information regarding past performance of at least one of the third parties with respect to providing accurate signals.

8. The method of claim 1 wherein conducting on-line auctions comprises receiving bids for individual ones of the plurality of signals.

9. The method of claim 8 wherein at least one of the bids comprises a fixed level of consideration.

10. The method of claim 8 wherein at least one of the bids comprises a contingent level of consideration.

11. The method of claim 1 further comprising:
vetting the third parties to authenticate their authorized status to offer the signals via the on-line auctions.

12. The method of claim 1 further comprising:
offering and providing use of software-based financial-investment analysis tools.

13. The method of claim 12 wherein at least one of the software-based financial-investment analysis tools is controlled by at least one of the third parties.

14. The method of claim 1 further comprising:
pushing information regarding an auction for at least one of the signals to predetermined recipients.

15. The method of claim 1 wherein conducting on-line auctions for individual ones of the plurality of signals comprises, at least in part, conducting at least one on-line auction for a corresponding one of the plurality of signals to permit a plurality of winner bidders to each receive that signal.

16. The method of claim 15 wherein conducting at least one on-line auction for a corresponding one of the plurality of signals to permit a plurality of winner bidders to each receive that signal further comprises:
permitting a first number of winning bidders to each receive a fresher version of the signal;
permitting a second number of winning bidders to each receive a less-fresh version of the signal.

17. The method of claim 1 wherein conducting on-line auctions for individual ones of the plurality of signals comprises, at least in part, conducting at least one on-line auction that is contingent upon being able to successfully access at least one other auctioned signal.

18. The method of claim 1 wherein conducting the on-line auctions further comprises conducting on-line auctions that offer access to pre-signal data that is presented as a suitable data source for at least one corresponding signal pertaining to financial investment quantitative analysis.

19. An apparatus comprising:
a memory;
a server platform operably coupled to the memory and configured to:
receive identifying information regarding a plurality of signals pertaining to financial investment quantitative analysis from various third parties and to store the identifying information in the memory;
post at least some of the identifying information via end-user browsers;
conduct on-line auctions for individual ones of the plurality of signals.

20. The apparatus of claim 19 wherein the server platform is further configured to:
offer and provide use of software-based financial-investment analysis tools via end-user browsers.
